(19) United States
(12) Patent Application Publication
(10) Pub. No.: US 2006/0194636 A1
(43) Pub. Date: Aug. 31, 2006

(54) Spindle sleeve for a machine tool

(75) Inventors: Lutz Muller, Chemnitz (DE); Andreas Zander, Chemnitz (DE)

Correspondence Address: LERNER GREENBERG STEMER LLP, P O BOX 2480, HOLLYWOOD, FL, 33022-2480, US

(73) Assignee: Union Werkzeugmaschininen GmbH Chemntz

(21) Appl. No.: 10/547,277

(22) PCT Filed: Jul. 1, 2004
(86) PCT No.: PCT/DE04/01390

§ 371 Date: Aug. 30, 2005

(30) Foreign Application Priority Data
Jul. 2, 2003 (DE) 103 29 590.9

(51) Int. Cl. B23Q 11/00

(52) U.S. Cl. 464/183

(57) ABSTRACT

The aim of the invention is to develop a spindle sleeve for a machine-tool, whose thermal expansion can be measured with a reduced technical complexity and a high degree of reliability and precision for compensation purposes. To achieve this: a component (2) is placed coaxially in the spindle sleeve (1), said component being connected to the spindle sleeve (1) in a fixed manner in the vicinity of the force-fit between the tool and the spindle sleeve (1), extending as far as the end of the spindle sleeve (1) in the bearing carriage (4) and being axially supported in said bearing carriage (4); the spindle sleeve (1) has a thermal expansion coefficient that differs from that of the component (2); and during temperature fluctuations the alterations in length of the spindle sleeve (1) in relation to the component (2) are detected in the form of output signals by means of a sensor (7) as a result of the different magnitudes of the two thermal expansion coefficients and are converted into compensation values for the position-controlled displacement of the spindle sleeve by means of the bearing carriage (4), using an electronic evaluation system and a tool-control mechanism.

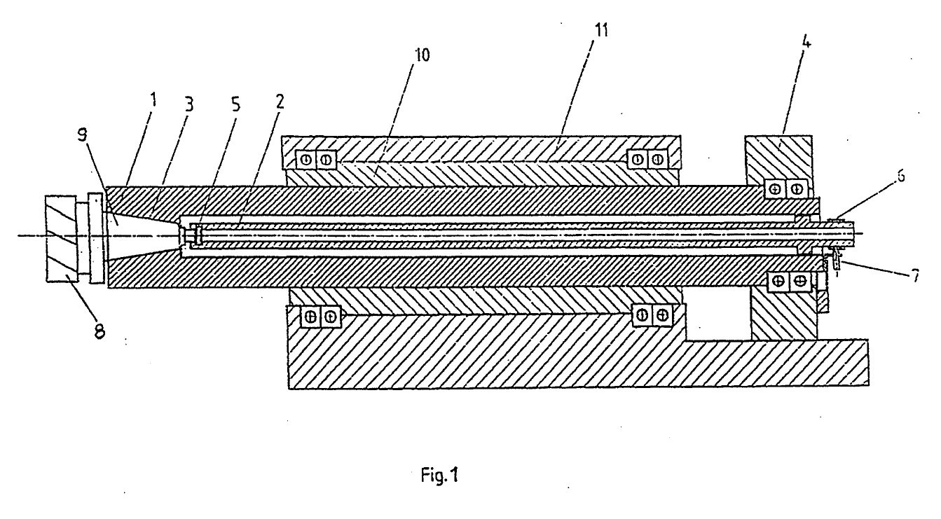

The invention relates to a machine-tool spindle sleeve having a tool receptacle for tools with a tool holder and a taper for the frictional connection to a spindle sleeve made of steel, the spindle sleeve being guided in a longitudinally displaceable manner in a hollow spindle rotatably mounted in a machining unit and being arranged in a rotatable and axially supported manner in a bearing carriage at an end opposite the tool receptacle.

It is known that temperature measuring points are arranged for the detection of the thermal state of the work spindles of machine tools. In this case, precision resistors, as sensors, are inserted longitudinally into the spindle at equal distances apart and are encapsulated with synthetic resin. A measured-value transmission device working in a noncontact manner is arranged at the rear spindle end from the revolving spindle to the fixed bearing block, so that the signals can be relayed for the measured-value processing with digitizing. The transmission of the measured temperature values acts independently of the spindle speed from stoppage up to maximum speed. Both the control of the precision resistors and the output of the measured values is effected over a telemetric distance. The spindle expansions calculated from the measured values are the output variables for the compensations to be effected via the CNC control. This method of determining the thermal expansion of the work spindle for compensation purposes is also relevant in the case of a machine-tool spindle sleeve.

In a machine-tool spindle sleeve having a tool receptacle for tools with a tool holder and a taper for the frictional connection to the spindle sleeve, the spindle sleeve is rotatably mounted in a hollow spindle of a machining unit and is arranged in a rotatable and axially supported manner in a bearing carriage at the opposite end. This compensation arrangement has the disadvantage that this involves considerable technical complexity in order to detect and transmit the measured values for the purpose of calculating the thermal expansion. Furthermore, the thermal expansion depends in principle on the measured values, so that incorrect measured values result in incorrect determination of expansion, which furthermore results in an incorrect value of the axial infeed of the spindle sleeve.

DE 10123717 A1 discloses a spindle shaft for a motor spindle which is accommodated in the housing of the motor spindle in a fixed bearing arrangement and a movable bearing arrangement, the mounted tool making contact with the machined workpiece at a tool interface when the spindle shaft is driven, and the tool interface being displaced in the axial direction of the spindle shaft during the processing of the workpiece, a displacement sensor being provided on the spindle bearing arrangement for determining the axial displacement of the tool interface.

DE 4009461 A1 has a spindle for a machine tool, which spindle comprises a cylindrical element for accommodating the shank of a tool, this element being produced by winding carbon or glass fibers, the wound fibers being impregnated with a curable resin. Due to the construction, it is possible to reduce the coefficients of linear expansion of the spindle and to thereby improve the machining accuracy.

The object of the invention is to develop a machine-tool spindle sleeve having a tool receptacle for tools with a tool holder and a taper for the frictional connection to a spindle sleeve made of steel, the spindle sleeve being guided in a longitudinally displaceable manner in a hollow spindle rotatably mounted in a machining unit and being arranged in a rotatable and axially supported manner in a bearing carriage at an end opposite the tool receptacle, in which machine-tool spindle sleeve, with reduced technical complexity, the thermal expansion of the spindle sleeve is detected with a high degree of reliability and accuracy for compensation purposes.

According to the invention, the object is achieved in that a component is arranged coaxially in the spindle sleeve, said component being firmly connected to the spindle sleeve in the region of the frictional connection between the tool and the spindle sleeve and extending lengthwise up to the end of the spindle sleeve in the bearing carriage and being arranged in the bearing carriage in an axially supported manner, the spindle sleeve has a different thermal expansion coefficient from that of the component, and, during changes in temperature, the changes in length of the spindle sleeve relative to the component on account of the different magnitudes of the two thermal expansion coefficients are detected as output signals by means of a sensor and are converted via an electronic evaluating system and a machine control into compensation values for the position-controlled adjustment of the spindle sleeve by means of the bearing carriage. Subclaims 2 to 9 show further embodiments of the invention.

The invention is explained in more detail below with reference to an exemplary embodiment. The associated drawing shows the longitudinal section through a machine-tool spindle sleeve.

The drawing shows a machine-tool spindle sleeve having a tool receptacle 3 for tools 8 with a tool holder and a taper 9 for frictional connection to a spindle sleeve 1. The spindle sleeve 1 is produced from steel. It is guided in a longitudinally displaceable manner in a hollow spindle 10 rotatably mounted in a machining unit 11 and is arranged in a in a bearing carriage 4 in such a way as to be rotatable relative to the tool receptacle 3 and so as to be axially supported. Arranged coaxially in the spindle sleeve 1 is a component 2 which is firmly connected in the region of the frictional connection between the tool and the spindle sleeve 1 and extends lengthwise up to the end of the spindle sleeve 1 in the bearing carriage 4 and is arranged in the bearing carriage 4 in an axially supported manner. This component 2 has a thermal expansion coefficient which is several times lower than the thermal expansion coefficient of the spindle sleeve 1. The component 2 may be produced from a carbon-fiber composite material, the thermal expansion coefficient of which is equal to zero. The component 2 may also be made of a material whose thermal expansion coefficient is several times higher than that of the spindle sleeve 1. On account of these relatively large differences in the thermal expansion coefficients of the two coaxially arranged construction members—spindle sleeve 1 and component 2—changes in length of the end of the spindle sleeve 1 relative to the end of the component 2 occur during changes in temperature. These changes in length are detected by a sensor and, as output signals, are converted via an electronic evaluating system and a machine control into compensation values for the position-controlled adjustment of the spindle sleeve by means of the bearing carriage 4. In the figure, the sensor is designed as a displacement sensor, a measuring sleeve 6 being fastened to the component 2 in the region of the bearing carriage 4 and a sensor 7 being fastened to the bearing carriage 4. The component 2 is a rod of a clamping system 5 for the frictional connection between the tool 8 and the spindle sleeve 1. However, it may also be a tube which is firmly connected to the spindle sleeve 1 in the region of the frictional connection between the tool and the spindle sleeve 1. In a further embodiment of the invention, the sensor is designed as a force sensor, the clamping force for the frictional connection between the tool 8 and the spindle sleeve 1 being applied by springs at the end of the rod, and the changes in the clamping force on account of the change in length of the spindle sleeve during changes in temperature being detected and being converted via the electronic evaluating system and the machine control into compensation values.

### DESIGNATIONS

1 Spindle sleeve
2 Component
3 Tool receptacle
4 Bearing carriage
5 Clamping system
6 Measuring sleeve
7 Sensor
8 Tool
9 Taper
10 Hollow spindle
11 Machining unit

1-9. (canceled)

10. A machine-tool spindle sleeve assembly, comprising:
a spindle sleeve of steel;
a tool receptacle for receiving a tool with a tool holder and a taper for frictional connection to said spindle sleeve;
a hollow spindle rotatably mounted in a machining unit;
said spindle sleeve being guided longitudinally displaceably in said hollow spindle and being rotatably mounted and axially supported in a bearing carriage at a distal end of said hollow spindle opposite said tool receptacle;
a component disposed coaxially in said spindle sleeve and rigidly connected to said spindle sleeve in a region of the frictional connection between the tool and said spindle sleeve, said component extending lengthwise up to the distal end of the spindle sleeve in said bearing carriage and being mounted in said bearing carriage with axial support;
said spindle sleeve having a coefficient of thermal expansion different from a coefficient of thermal expansion of said component;
a sensor disposed to detect a change in length of said spindle sleeve relative to said component on account of a change in temperature, due to the mutually different coefficients of thermal expansion, and to output an output signal; and
an electronic evaluating system and machine control receiving the output signal from said sensor, and forming therefrom compensation values for a position-controlled adjustment of said spindle sleeve by way of said bearing carriage.

11. The machine-tool spindle sleeve according to claim 10, wherein the coefficient of thermal expansion of said spindle sleeve is at least two times greater than the coefficient of thermal expansion of said component.

12. The machine-tool spindle sleeve according to claim 10, wherein the coefficient of thermal expansion of said spindle sleeve is at least two times lower than the coefficient of thermal expansion of said component.

13. The machine-tool spindle sleeve according to claim 10, wherein the component is produced from a carbon-fiber composite material whose coefficient of thermal expansion is equal to zero.

14. The machine-tool spindle sleeve according to claim 10, wherein said component is produced from a steel grade having a coefficient of thermal expansion several times lower than the coefficient of thermal expansion of said spindle sleeve.

15. The machine-tool spindle sleeve according to claim 10, wherein said component is a tube.

16. The machine-tool spindle sleeve according to claim 10, wherein said component is a rod of a clamping system for the frictional connection between the tool and said spindle sleeve.

17. The machine-tool spindle sleeve according to claim 10, wherein said sensor is a displacement sensor, a measuring sleeve is fastened to said component in a region of said bearing carriage and said sensor is fastened to said bearing carriage.

18. The machine-tool spindle sleeve according to claims 10, wherein said sensor is a force sensor, a clamping force for the frictional connection between the tool and said spindle sleeve is applied by springs disposed at the end of said component, and changes in the clamping force on account of the change in length of said spindle sleeve during changes in temperature are detected and converted into the compensation values for the position-controlled adjustment of said spindle sleeve by way of said bearing carriage.
